(19) United States
(12) Patent Application Publication
(10) Pub. No.: US 2016/0303926 A1
(43) Pub. Date: Oct. 20, 2016

(54) Upgradable Universal Tire Pressure Monitoring Device, System, and System Implementation Methods

(71) Applicant: Autel Intelligent Technology Co., Ltd., Shenzhen (CN)

(72) Inventors: Li Hongjing, Shenzhen (CN); Hao Yan, Shenzhen (CN)

(73) Assignee: Autel Intelligent Technology Co., Ltd., Shenzhen (CN)

(21) Appl. No.: 14/085,705

(22) Filed: Nov. 20, 2013

(30) Foreign Application Priority Data
Aug. 20, 2013 (CN) 201310364798.3

(51) Int. Cl. B60C 23/04

(52) U.S. Cl. CPC B60C 23/0452; B60C 23/0486; B60C 23/0488; B60C 23/041

(57) ABSTRACT

This invention relates to tire pressure monitoring technology. More particularly, the invention relates to upgradeable universal tire pressure monitoring device, system, and system implementation methods. The upgradeable universal tire pressure monitoring device itself has stored upon delivery the program meeting the functional requirements of one type of tire pressure monitoring device. It can be a substitute for one type of tire pressure monitoring device, and users can use it directly without purchasing an external upgrade device; the tire pressure monitoring device can receive, store, and execute a new version of a program or a program meeting the functional requirements of another type of tire pressure monitoring device, which is sent by external upgrade device so as to complete program upgrading or become the tire pressure monitoring device that meets functional requirements of another type of tire pressure monitoring device, and thus achieve the compatible and universal effect.

### CROSS REFERENCE TO RELATED APPLICATION

This application is based on, and claims the benefit of priority to, the Chinese patent application Ser. No. 201310364798.3, entitled “Upgradeable Universal Tire Pressure Monitoring Device, System, And System Implementation Methods” filed on Aug. 20, 2013, the content of which is incorporated in its entirety by reference herein.

### FIELD OF THE INVENTION

This invention relates to tire pressure monitoring technology. More particularly, the invention relates to an upgradeable universal tire pressure monitoring device, the system, and the system implementation methods.

### BACKGROUND OF THE INVENTION

The Tire Pressure Monitoring System (TPMS) is a warning device for safeguarding the lives of drivers and passengers. It is mainly used to automatically monitor tire pressure and send an alarm when there is a flat tire and low tire pressure while the vehicle is being driven. The tire pressure monitoring device is a tire pressure monitoring module installed on the tire. At this time, there is no unified standard for tire pressure monitoring devices on the current market. Tire pressure monitoring devices vary among manufactures and vehicle model types. Even vehicles of the same model type with different model years can have different tire pressure monitoring devices that are incompatible due to algorithm differences of pressure, temperature, acceleration, and different LF protocol, RF protocol, etc. The program in the device cannot be changed and different types of tire pressure monitoring devices cannot share programs with each other. Therefore, the technician must find a tire pressure monitoring device of the same type when the original device stops working. The requirements of different types of tire pressure monitoring devices among the wide variety of vehicle brands, model types, and model years not only bring great inconvenience to users and technicians but also raise maintenance costs due to the rise of logistics and time inventory.

The programmable universal tire pressure monitoring device solves these problems, but there are also many deficiencies. The programmable universal tire pressure monitoring devices on the market generally fall into two types. The first type implements boot code, and the device itself has many previously stored programs. Depending on the model type and model year users select, this type of device will send a specific enabling signal to the tire pressure monitoring device. The tire pressure monitoring device has many programs stored by a limit programming device to make it execute a specific program, thus enabling the device to meet the functional requirements of another type of tire pressure monitoring device. This type of universal tire pressure monitoring device greatly increases the risk of program errors because the device itself has multiple programs stored. It also negatively influences the operational efficiency of the program. The other type of programmable universal tire pressure monitoring device implements a loading code program. Depending on the model type and model year users have selected, this type of device will send a specific code program to the tire pressure monitoring device that has not yet loaded the program. This is done using a limit programming device, enabling the device to meet the functional requirements of another type of tire pressure monitoring device.

The above two types of programmable universal tire pressure monitoring devices must use the limit program device in line with them to enable or load a code program so that they can become tire pressure monitoring devices that meet the functional requirements of other types of tire pressure monitoring devices. Therefore, users must purchase the limit program device when they buy the tire pressure monitoring device, which increases users' cost greatly.

Therefore it would be desirable to provide an upgradeable universal tire pressure monitoring device, system, and system implementation methods.

### SUMMARY OF THE INVENTION

The present invention offers an upgradeable universal tire pressure monitoring device system and system implementation methods. The upgradeable universal tire pressure monitoring device itself has a pre-stored program meeting the functional requirements of one type of tire pressure monitoring device upon delivery. It can be a substitute for one type of tire pressure monitoring device, and users can use it directly without purchasing an external upgrade device. The tire pressure monitoring device can receive, store, and execute a new version of a program or a program meeting the functional requirements of another type of tire pressure monitoring device, which is sent by an external upgrade device so as to complete program upgrading or become the tire pressure monitoring device that meets the functional requirements of another type of tire pressure monitoring device. This invention can decrease users' cost greatly and users can upgrade it to another type of tire pressure monitoring device when necessary and thus achieve the compatible and universal effect.

In one preferred embodiment of the invention, an upgradeable universal tire pressure monitoring device is disclosed. The universal tire pressure monitoring device includes:

A tire pressure monitoring module, the functions of which include monitoring the pressure and temperature inside a tire, monitoring acceleration of the tire, receiving external low frequency data, sending signals processed in the tire pressure monitoring module to an external monitoring device, and storing and executing a program meeting the functional requirements of one type of tire pressure monitoring device; and

An antenna module, connected with the tire pressure monitoring module, comprising a low frequency receiving antenna and a high frequency receiving antenna, where the low frequency receiving antenna is used to receive external low frequency data while the high frequency receiving antenna is used to send signals processed in the tire pressure monitoring module to the external monitoring device.

The tire pressure monitoring device of the invention can receive, store, and execute a new version of a program sent by the external upgrade device or a program that meets the functional requirements of another type of tire pressure monitoring device so as to complete program upgrading or become a tire pressure monitoring device that meets the functional requirements of another type of tire pressure monitoring device.

In another preferred embodiment of the invention, the tire pressure monitoring device also includes:

A power module connected to the tire pressure monitoring module, which is used to supply power to the tire pressure monitoring module.

In another preferred embodiment of the invention, the program stored and executed by tire pressure monitoring module can be divided into a boot code module, a basic performance function module, and an application module. The functions of the boot code module include completing initialization of the tire pressure monitoring module and booting the stored program to the application module. The functions of the basic performance function module include measuring pressure, temperature, battery voltage, acceleration, and converting encoding format. The application module is used to execute a program so as to make the tire pressure monitoring device become one that meets the functional requirements of another type of tire pressure monitoring device.

In another preferred embodiment of the invention, an upgradeable universal tire pressure monitoring system is disclosed. The tire pressure monitoring system is comprised of a tire pressure monitoring device and an external upgrade device. The external upgrade device and the tire pressure monitoring device are connected via a communication connection. The external upgrade device of the invention is used to send a previously stored program or one obtained externally that meets the functional requirements of another type of tire pressure monitoring device to the tire pressure monitoring device, and then the tire pressure monitoring device will execute the program, making the tire pressure monitoring device become one that meets the functional requirements of another type of tire pressure monitoring device.

In another preferred embodiment of the invention, the communication connection is a wired connection or wireless connection.

In another preferred embodiment of the invention, a method for implementing an upgradeable universal tire pressure monitoring system is disclosed. The method includes the following steps:

Take a tire pressure monitoring device, which has a program stored that meets the functional requirements of one type of tire pressure monitoring device;

When users need to upgrade the program of the tire pressure monitoring device or have it become a tire pressure monitoring device that meets the functional requirements of another type of tire pressure monitoring device, an external upgrade device will select a new version of a program or a program meeting the functional requirements of another type of tire pressure monitoring device, and send the program to the tire pressure monitoring device; and

When the tire pressure monitoring device has identified that the tire is not in use and the device's programming function is not closed, it will receive, store, and execute a new version of a program or a program meeting the functional requirements of another type of tire pressure monitoring device, which are sent by the external upgrade device so as to complete program upgrading or become a tire pressure monitoring device that meets the functional requirements of another type of tire pressure monitoring device.

In another preferred embodiment of the invention, the method also includes the following:

When the tire pressure monitoring device has received a request signal sent by the external upgrade device, it will identify whether or not the tire is in use. If it is, the tire pressure monitoring device will not respond to the request signal sent by the external upgrade device.

In another preferred embodiment of the invention, the method also includes the following:

The programming function itself will close as soon as the tire pressure monitoring device identifies that the tire is in use.

In another preferred embodiment of the invention, the method also includes the following:

The programming function itself will close when the tire pressure monitoring device receives a specific signal sent by a limit programming device.

In another preferred embodiment of the invention, the method also includes the following:

Close the programming function of tire pressure monitoring device with an external switch.

The invention has the following advantages:

The upgradeable universal tire pressure monitoring device itself has a stored program meeting functional requirements of one type of tire pressure monitoring device upon delivery. It can be a substitute for one type of tire pressure monitoring device, and users can use it directly without purchasing an external upgrade device. The tire pressure monitoring device can receive, store, and execute a new version of a program or a program meeting the functional requirements of another type of tire pressure monitoring device, which are sent by an external upgrade device so as to complete program upgrading or become a tire pressure monitoring device that meets the functional requirements of another type of tire pressure monitoring device. This invention can decrease users' cost greatly and users can upgrade it to another type of tire pressure monitoring device when necessary, thus achieving the compatible and universal effect.

### BRIEF DESCRIPTION OF THE DRAWINGS

FIG. 1 is a schematic diagram illustrating the hardware structure of an upgradeable universal tire pressure monitoring device 100 according to one preferred embodiment of the invention.

FIG. 2 is a schematic diagram illustrating the program 200 stored and executed in the tire pressure monitoring module 120 according to the invention.

FIG. 3 is a schematic diagram of a tire pressure monitoring system 300 according to one preferred embodiment of the invention.

FIG. 4 is a flow chart diagram illustrating an implementation method of the upgradeable universal tire pressure monitoring system 100 according to the invention.

### DESCRIPTION OF THE INVENTION

While the present invention may be embodied in many different forms, designs or configurations, reference will be made to the embodiments illustrated in the drawings and specific language will be used to describe the same for the purpose of promoting an understanding of the principles of the invention. It will nevertheless be understood that no limitation or restriction of the scope of the invention is thereby intended. Any alterations and further implementations of the principles of the invention as described herein are contemplated as would normally occur to one skilled in the art to which the invention relates.

This invention offers an upgradeable universal tire pressure monitoring device, the system, and the system implementation methods. Upon delivery, the upgradeable universal tire pressure monitoring device itself has a program stored that meets the functional requirements of one type of tire pressure monitoring device. It can be a substitute for one type of tire pressure monitoring device, and users can use it directly without purchasing an external upgrade device. The tire pressure monitoring device can receive, store, and execute a new version of a program or a program meeting the functional requirements of another type of tire pressure monitoring device, which is sent by an external upgrade device so as to complete program upgrading or become the tire pressure monitoring device that meets the functional requirements of another type of tire pressure monitoring device. This invention can decrease users' cost greatly and users can upgrade it to another type of tire pressure monitoring device when necessary, thus achieving the compatible and universal effect.

In one preferred embodiment of the invention, an upgradeable universal tire pressure monitoring device is disclosed. The universal tire pressure monitoring device includes:

A tire pressure monitoring module, the functions of which include monitoring the pressure and temperature inside a tire, monitoring the acceleration of the tire, receiving external low frequency data, sending signals processed in the tire pressure monitoring module to an external monitoring device, and storing and executing a program meeting the functional requirements of one type of tire pressure monitoring device; and

An antenna module, connected with the tire pressure monitoring module, comprising a low frequency receiving antenna and a high frequency receiving antenna, where the low frequency receiving antenna is used to receive external low frequency data while the high frequency receiving antenna is used to send signals processed in the tire pressure monitoring module to the external monitoring device.

The tire pressure monitoring device of the invention can receive, store, and execute a new version of a program sent by the external upgrade device or a program meeting the functional requirements of another type of tire pressure monitoring device so as to complete program upgrading or become a tire pressure monitoring device that meets the functional requirements of another type of tire pressure monitoring device.

In another preferred embodiment of the invention, the tire pressure monitoring device also includes:

A power module connected to the tire pressure monitoring module, which is used to supply power to the tire pressure monitoring module.

In another preferred embodiment of the invention, the program stored and executed by tire pressure monitoring module can be divided into a boot code module, a basic performance function module, and an application module. The functions of the boot code module include completing initialization of the tire pressure monitoring module and booting the stored program to the application module; the functions of basic performance function module include measuring pressure, temperature, battery voltage, and acceleration, converting encoding format; and the application module is used to execute a program so as to make the tire pressure monitoring device become one that meets the functional requirements of another type of tire pressure monitoring device.

In another preferred embodiment of the invention, an upgradeable universal tire pressure monitoring system is disclosed. The tire pressure monitoring system is comprised of a tire pressure monitoring device and an external upgrade device. The external upgrade device and the tire pressure monitoring device are connected via a communication connection. The external upgrade device of the invention is used to send a program to the tire pressure monitoring device, wherein said program is either previously stored in the external upgrade device or obtained externally and meets the functional requirements of another type of tire pressure monitoring device. Then the tire pressure monitoring device will execute the program, making the tire pressure monitoring device become one that meets the functional requirements of another type of tire pressure monitoring device.

In another preferred embodiment of the invention, the communication connection is either a wired connection or a wireless connection.

In another preferred embodiment of the invention, a method for implementing an upgradeable universal tire pressure monitoring system is disclosed. The method is comprised of the following steps:

Take a tire pressure monitoring device that stores a program meeting the functional requirements of one type of tire pressure monitoring device;

When users need to upgrade the program of the tire pressure monitoring device or have it become a tire pressure monitoring device that meets the functional requirements of another type of tire pressure monitoring device, an external upgrade device will select a new version of the program or a program meeting functional requirements of another type of tire pressure monitoring device and send the program to the tire pressure monitoring device; and

When the tire pressure monitoring device's programming function is open and has identified that the tire is not in use, it will receive, store, and execute a new version of a program or a program meeting the functional requirements of another type of tire pressure monitoring device, which are sent by the external upgrade device so as to complete program upgrading or become a tire pressure monitoring device that meets the functional requirements of another type of tire pressure monitoring device.

In another preferred embodiment of the invention, the method also includes the following:

When the tire pressure monitoring device has received a request signal sent by the external upgrade device, it will identify whether or not the tire is in use. If the tire is in use, the tire pressure monitoring device will not respond the request signal sent by the external upgrade device.

In another preferred embodiment of the invention, the method also includes the following:

The device's programming function will close as soon as the tire pressure monitoring device identifies that the tire is in use.

In another preferred embodiment of the invention, the method also includes the following:

The device's programming function will close when the tire pressure monitoring device receives a specific signal sent by a limit programming device.

In another preferred embodiment of the invention, the method also includes the following:

Close the programming function of tire pressure monitoring device with an external switch.

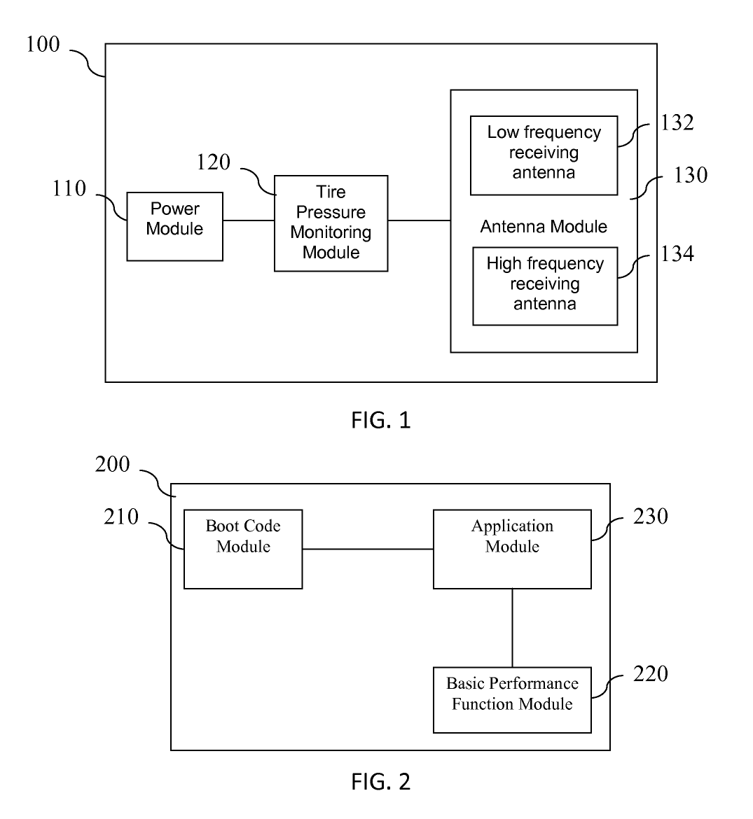

FIG. 1 is a schematic diagram illustrating the hardware structure of an upgradeable universal tire pressure monitoring device 100 according to one preferred embodiment of the invention. The upgradeable universal tire pressure monitoring device 100 includes: a power module 110, a tire pressure monitoring module 120 and an antenna module 130.

The power module 110, connected with tire pressure monitoring module 120, is used to supply power to the tire pressure monitoring module 120;

The tire pressure monitoring module 120 is used to sense the internal pressure, temperature, and acceleration of the tire, receive external low frequency data, send processed signals in the tire pressure monitoring module 120 to an external monitor device, and store and execute a program that meets the functional requirements of a pressure sensing device model.

The antenna module 130 is connected to the tire pressure monitoring module 120. It contains a low frequency receiving antenna 132 and a high frequency receiving antenna 134. The low frequency receiving antenna 132 is used to receive external low frequency data, and the high frequency receiving antenna 134 is used to send signals internally processed in the tire pressure monitoring module 120 to an external monitor device.

The low frequency receiving antenna 132 is used to receive external low frequency data and the low frequency activation signal sent by both an external activation device and a signal receiving device installed in the vehicle. The low frequency receiving antenna 132 includes a new version of a program sent by an external upgrade device or a program that meets the functional requirements of another tire pressure sensing device model.

The tire pressure monitoring device 100 can receive and store a new version of a program sent by the external upgrade device or a program that meets the functional requirements of another tire pressure sensing device model. It can also execute the new version of the program or the program that meets the functional requirements of another tire pressure monitoring device model, making the device finish the program upgrading or meet the functional requirements of another tire pressure monitoring device model.

The tire pressure monitoring device 100 communicates with two external devices; one is the external upgrade device, and the other is the external monitoring device.

Communication with the external monitoring device: The tire pressure monitoring device 100 processes the sensed internal pressure, temperature and acceleration of the tire. It then sends the data to the external monitoring device to monitor a flat tire, low pressure, and other tire statuses in real time, sending an alarm when necessary to ensure safety.

Communication with the external upgrade device: There is no unified standard for the tire monitor device on the current market. Tire pressure monitor devices may be different from each other whether they are on vehicle models from different manufacturers or the same manufacturer. Different types of tire pressure monitoring devices are incompatible. Upon delivery, the tire pressure monitor device 100 of the present invention has already stored a program that is required by one tire pressure monitor device model. Users can replace another tire pressure monitor device model with the tire pressure monitor device 100 and use it directly without purchasing an external upgrade device. When users want to upgrade the program of the tire pressure monitor device 100 or make it become a certain tire pressure monitoring device that meets the functional requirements of another tire pressure monitor device model, it can receive and store a new version of a program sent by the external upgrade device or a program that meets the functional requirements of another tire pressure monitoring device model. It can also execute the new version of the program or the program that meets the functional requirements of another tire pressure monitoring device model, making the tire pressure monitoring device 100 finish program upgrading or become a certain tire pressure monitoring device that meets the functional requirements of another tire pressure monitoring device model. For example, the tire pressure monitoring device 100 already has the “Toyota Camry 2012” program stored upon delivery. Users can replace the tire pressure monitoring device on “Toyota Camry 2012” with this tire pressure monitoring device 100 of the invention, and use it directly without purchasing an external upgrade device. When users want to upgrade the tire pressure monitoring device 100 to the tire pressure monitoring device on the “Kia K5 2012” model, it can receive, store, and execute the program of “Kia K5 2012” sent by an external upgrade device, making the tire pressure monitoring device 100 become the tire pressure monitoring device of the “Kia K5 2012” model.

The upgradeable universal tire pressure monitoring device 100 of the present invention can reduce the cost for users, since users can use it directly without purchasing an external upgrade device. It can upgrade to another tire pressure monitoring device model when necessary and thus achieve universal compatibility.

FIG. 2 is a schematic diagram illustrating the program 200 stored and executed in the tire pressure monitoring module 120 according to the invention. The program 200 stored and executed by the tire pressure monitoring module 120 can be divided into the following three modules: a boot code module 210, a basic performance function module 220, and an application module 230.

The boot code module 210 and the basic performance function module 220 are solidification program modules, which are solidified in the tire pressure monitoring module 120; and the application module 230 is an open program module, which can be sent by an outside external device.

Furthermore, the boot code module 210 is used to finish the initialization of the tire pressure monitoring module 120 and boot the stored program to the application module 230 to execute. The stored program includes the program stored by the tire pressure monitoring module 120 itself upon delivery and the program received from an external device, which is stored by the tire pressure monitoring device 100. The basic performance function module 220 is used to measure tire pressure, temperature and acceleration, battery voltage, and convert encoding format. The application module 230 is used to execute the program that makes the device meet the functional requirements of certain tire pressure monitoring device models.

For example, when executing the program A stored within the tire pressure monitoring module 120 upon delivery, program A will be booted to the application module 230 by the boot code module 210 for execution. Some basic functions will be needed to execute program A. At the time of execution, program A only calls related functions in the basic performance function module 220 without writing the basic functions into it. In other words, the address of each function in the basic performance function module 220 is fixed and known. It only needs to write one statement to call the function of a certain address if this function is needed in writing program A. When executing program A in the application module 230, it can call the function stored in the basic performance function module 220 without writing the function into program A. Thus, it can reduce the amount of code used in the program, shorten the upgrade programming time, and improve the program execution efficiency. For another example, if program B is sent from an external device to the tire pressure monitoring device 100, the tire pressure monitoring device 100 will receive and store program B first, and then program B will be booted into the application module 230 by the boot code module 210. Some basic functions will be needed in executing program B. At this time, program B only calls relative functions in the basic performance function module 220 without writing the basic functions into it.

The program stored and executed by the tire pressure monitoring module of the present invention can be divided into these three modules: a boot code module, a basic performance function module, and an application module. Users reprogram the application module only, and the existence of the basic performance function module reduces the amount of code used in the program, shortens the upgrading and programming time, and increases the efficiency of the program's execution.

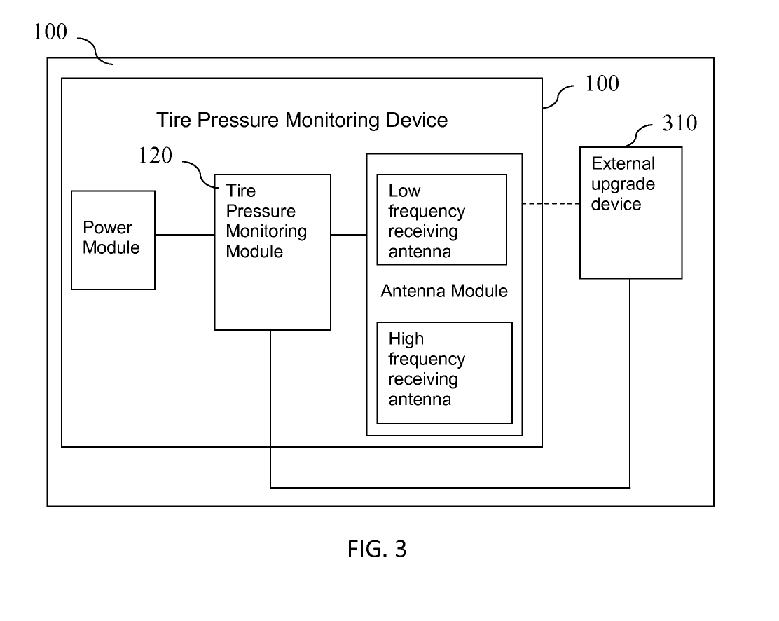

FIG. 3 is a schematic diagram of a tire pressure monitoring system 300 according to one preferred embodiment of the invention. The upgradeable universal tire pressure monitoring system 300 includes the tire pressure monitoring device 100 and an external upgrade device 310, which are connected via a communication connection.

The external upgrade device 310 stores a program that meets the functional requirements of a certain pressure monitoring device model, and it can obtain this program via a wired or wireless connection. For example, the external upgrade device can obtain the program from a desktop computer via a wired connection or from a laptop via blue tooth technology.

The external upgrade device 310 and the tire pressure monitoring device 100 are connected with communication connections that include wired and wireless connections. When they are connected via a wireless connection, they are connected through the low frequency antenna 132. The external upgrade device 310 sends the previously stored program or a program obtained externally that meets the functional requirements of a certain tire pressure monitoring device model to the tire pressure monitoring device 100, make the tire pressure monitoring device 100 execute the program and become a tire pressure monitoring device that meets the functional requirements of a certain tire pressure monitoring device model.

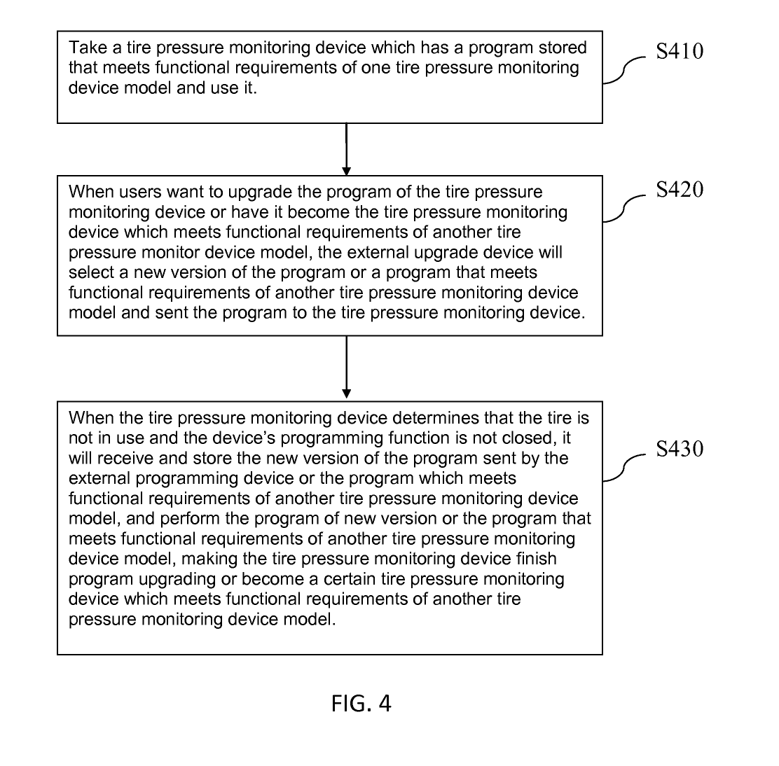

FIG. 4 is a flow chart diagram illustrating an implementation method of the upgradeable universal tire pressure monitoring system 100 according to the invention. The method includes the following steps:

Step S410: Take the tire pressure monitoring device 100, which has stored the program that meets functional requirements of one tire pressure monitoring device model and use it;

Step S420: When users want to upgrade the program of the tire pressure monitoring device or make it become a tire pressure monitoring device that meets the functional requirements of another tire pressure monitor device model, an external upgrade device will select a new version of a program or a program that meets the functional requirements of another tire pressure monitoring device model and send the program to the tire pressure monitoring device 100;

Step S430: When the tire pressure monitoring device 100 determines that the tire is not in use and its programming function is not closed, it will receive and store the new version of the program sent by the external programming device or the program which meets the functional requirements of another tire pressure monitoring device model, and execute the new version of the program or the program that meets functional requirements of another tire pressure monitoring device model, making the tire pressure monitoring device 100 finish program upgrading or become a certain tire pressure monitoring device that meets the functional requirements of another tire pressure monitoring device model.

The upgradeable universal tire pressure monitoring device of the present invention can greatly reduce the cost for users, since users can use it directly without purchasing an external programming device. This reduces the risk of operation errors, which affect the product's normal use. Users can upgrade this device to another tire pressure monitoring device model, thus achieving universal compatibility when necessary.

There are four methods of limit programming for the upgradeable universal tire pressure monitoring device 100. The methods are as follows:

1. After the tire pressure monitoring device 100 receives the request signal from the external upgrade device, it will determine whether or not the tire is in use. If it is, it will not respond to the request signal from the external device. The specific way for the tire pressure monitoring device 100 to determine whether the tire is in use is as follows: The tire pressure monitoring module 120 in the tire pressure monitoring device 100 can sense the internal pressure, temperature and acceleration of the tire. The tire pressure monitoring device 100 determines whether or not the tire is in use by determining the value of pressure, temperature, and acceleration respectively or comprehensively. For example, when using pressure as a determining factor, the tire pressure monitoring device 100 will consider the tire as “in use” if the sensed internal pressure of the tire is over 80 kPa. As a result, the tire pressure monitoring device 100 will refuse to respond to the request signal after receiving the request signal from the external upgrade device and will not allow the external upgrade device to amend the internal program of it. When determining whether or not the tire is in use using pressure and acceleration comprehensively, the tire pressure monitoring device 100 will consider the tire as “in use” if the sensed internal pressure of the tire is over 80 kPa and the cumulative time of the acceleration, which is over 3 g, is more than 30 minutes. So, the tire pressure monitoring device 100 will refuse to respond to the request signal after receiving the request signal from the external upgrade device and will not allow the external upgrade device to amend the internal program of it.
2. Set the tire pressure monitoring device to close the programming function: The tire pressure monitoring device 100 will close its programming function when it determines the tire is in use. This mechanism is particular to the tire pressure monitoring device 100 itself. In this method, the tire pressure monitoring device 100 will immediately close the programming function when it determines the tire is in use whether it has received the signal sent by the external device or not. This way, it can effectively avoid the program being amended when the tire pressure monitoring device is in use, thereby protecting the security for users. The method of determining the tire status for tire pressure monitoring devices is the same as the above described method 1, and will not be repeated here. The above two methods automatically close the programming function for tire pressure monitoring device 100. The following two methods manually close the programming function for the tire pressure monitoring device 100:
3. Close the programming function of the tire pressure monitoring device 100 when a specific signal is sent by a limit programming device;
4. Close the programming function of the tire pressure monitoring device 100 with its external switch.

These two methods are usually used in vehicle maintenance. The technician will close the programming function of the tire pressure monitoring device 100 with the specific signal sent from the limit programming device or with the external switch if users need it.

The methods of limit programming for the upgradeable universal tire pressure monitoring device of the present invention can effectively avoid the risk of amending the program of the tire pressure monitoring device when it is in use through the current mode of wireless programming.

This invention has the following advantages:

Upon delivery, the upgradeable universal tire pressure monitoring device itself has a stored program that meets the functional requirements of one type of tire pressure monitoring device. It can be a substitute for one type of tire pressure monitoring device, and users can use it directly without purchasing an external upgrade device. The tire pressure monitoring device can receive, store, and execute a new version of a program or a program meeting the functional requirements of another type of tire pressure monitoring device, which is sent by an external upgrade device so as to complete program upgrading or become a tire pressure monitoring device that meets the functional requirements of another type of tire pressure monitoring device. This invention can decrease users' cost greatly and users can upgrade it to another type of tire pressure monitoring device when necessary, thus enabling the invention to achieve the compatible and universal effect.

While one or more embodiments of the present invention have been illustrated above, the skilled artisan will appreciate that modifications and adoptions to those embodiments can be made without departing from the scope and spirit of the present invention.

1. An upgradeable universal tire pressure monitoring device, said tire pressure monitoring device comprising:
a tire pressure monitoring module for monitoring pressure and temperature inside a tire, monitoring acceleration of said tire, receiving external low frequency data, sending signals processed in said tire pressure monitoring module to an external monitoring device, and storing and executing a program meeting the functional requirements of another type of tire pressure monitoring device; and
an antenna module which is connected to said tire pressure monitoring module; wherein said antenna module comprises a low frequency receiving antenna and a high frequency transmitting antenna; wherein said low frequency receiving antenna is used to receive external low frequency data, and said high frequency transmitting antenna is used to send signals processed in tire pressure monitoring module to said external monitoring device;
wherein said tire pressure monitoring device receives, stores, and executes a new version of said program or a program meeting the functional requirements of another type of tire pressure monitoring device sent by said external upgrade device so as to complete program upgrading or become a tire pressure monitoring device that meets the functional requirements of another type of tire pressure monitoring device.

2. The upgradeable universal tire pressure monitoring device of claim 1, further comprising:
a power module, which is connected to said tire pressure monitoring module; wherein said power module is used to supply power to said tire pressure monitoring module.

3. The upgradeable universal tire pressure monitoring device of claim 1, wherein said program stored and executed by said tire pressure monitoring module is divided into a boot code module, a basic performance function module, and an application module; wherein the functions of said boot code module include completing initialization of said tire pressure monitoring module and booting said program to said application module; wherein the functions of said basic performance function module include measuring pressure, temperature, battery voltage, and acceleration, converting encoding format; and wherein said application module is used to execute said program so as to make said tire pressure monitoring device become one that meets the functional requirements of another type of tire pressure monitoring device.

4. An upgradeable universal tire pressure monitoring system comprising a tire pressure monitoring device and an external upgrade device, wherein said tire pressure monitoring device comprising:
a tire pressure monitoring module for monitoring pressure and temperature inside a tire, monitoring acceleration of said tire, receiving external low frequency data, sending signals processed in said tire pressure monitoring module to an external monitoring device, and storing and executing a program meeting the functional requirements of another type of tire pressure monitoring device; and
an antenna module which is connected to said tire pressure monitoring module; wherein said antenna module comprises a low frequency receiving antenna and a high frequency transmitting antenna; wherein said low frequency receiving antenna is used to receive external low frequency data, and said high frequency transmitting antenna is used to send signals processed in tire pressure monitoring module to said external monitoring device;
wherein said tire pressure monitoring device receives, stores, and executes said new version of said program sent by said external upgrade device or a program meeting the functional requirements of another type of tire pressure monitoring device so as to complete program upgrading or become a tire pressure monitoring device that meets the functional requirements of another type of tire pressure monitoring device;
wherein a connection method for communication is provided for connecting said external upgrade device and said tire pressure monitoring device; said external upgrade device is used to send a previously stored program or one obtained externally that meets the functional requirements of another type of tire pressure monitoring device to said tire pressure monitoring device; said tire pressure monitoring device executes said program, making said tire pressure monitoring device become one that meets the functional requirements of another type of tire pressure monitoring device.

5. The upgradeable universal tire pressure monitoring system of claim 4, wherein said connection method for communication is a wired connection or wireless connection.

6. A method for implementing an upgradeable universal tire pressure monitoring system, said method comprising steps of:
taking said upgradeable universal tire pressure monitoring device which has a program stored that meets the functional requirements of another type of tire pressure monitoring device and said upgradeable universal tire pressure monitoring device can be used directly,
when users need to upgrade said program of said tire pressure monitoring device or have said tire pressure monitoring device become a tire pressure monitoring device that meets the functional requirements of another type of tire pressure monitoring device, selecting by an external upgrade device a new version of said program or a program meeting the functional requirements of another type of tire pressure monitoring device, and sending said program to said tire pressure monitoring device; and
when said tire pressure monitoring device has identified that a tire is not in use and a programming function of said tire pressure monitoring device is not closed, receiving, storing, and executing, by said tire pressure monitoring device, said new version of a program or program meeting the functional requirements of another type of tire pressure monitoring device, which are sent by said external upgrade device so as to complete program upgrading or become a tire pressure monitoring device that meets the functional requirements of another type of tire pressure monitoring device.

7. The method for implementing an upgradeable universal tire pressure monitoring system of claim 6, wherein when said tire pressure monitoring device has received a request signal sent by said external upgrade device, said tire pressure monitoring device identifies whether or not said tire is in use; and where said tire is being used, said tire pressure monitoring device does not respond to said request signal sent by external upgrade device.

8. The method for implementing an upgradeable universal tire pressure monitoring system of claim 6, wherein said programming function closes as soon as said tire pressure monitoring device identifies that said tire is in use.

9. The method for implementing an upgradeable universal tire pressure monitoring system of claim 6, wherein said programming function closes when said tire pressure monitoring device receives a specific signal sent by a limit programming device.

10. The method for implementing an upgradeable universal tire pressure monitoring system of claim 6, further comprising a step of:
closing said programming function of said tire pressure monitoring device with an external switch on said tire pressure monitoring device.
